(19) United States
(12) Patent Application Publication
(10) Pub. No.: US 2010/0244555 A1
(43) Pub. Date: Sep. 30, 2010

(54) Three phase generator

(76) Inventors: Herbert Labitzke, Markgroeningen (DE); Gert Wolf, Affalterbach (DE); Reinhard Meyer, Bietigheim-Bissingen (DE)

Correspondence Address: KENYON & KENYON LLP, ONE BROADWAY, NEW YORK, NY, 10004, US

(21) Appl. No.: 11/661,508

(22) PCT Filed: Jul. 14, 2005
(86) PCT No.: PCT/EP05/53368

§ 371 Date: Nov. 16, 2007

(30) Foreign Application Priority Data
Aug. 27, 2004 (DE) 102004041510.2

(51) Int. Cl. B60L 1/00

(52) U.S. Cl. 307/9.1

(57) ABSTRACT

A three-phase generator includes an output voltage settable between a first voltage value and a second voltage value, in which the first voltage value is provided for supplying electrical system consumers of a motor vehicle. The second voltage value is greater than the first voltage value. The three-phase generator has a stator around whose teeth a three-phase winding is wound, whose winding phases are positioned in slots located between the teeth. To ensure a balanced power ratio within the different voltage levels, each winding has a predefined number of conductors per slot.

### FIELD OF THE INVENTION

The present invention relates to a three-phase generator and a device for voltage supply of the electrical system of a motor vehicle, which has a three-phase generator of this type.

### BACKGROUND INFORMATION

Three-phase generators for motor vehicles are typically designed in such a way that they meet the power requirements within a voltage level, e.g., 14 V, and a set of speeds as well as possible.

Furthermore, it is already known that generators which are designed for a first operating voltage of 14 V, for example, may deliver a higher power with significantly improved efficiency at a second operating voltage, which is higher than the first operating voltage.

Furthermore, it is already known that the startup speed of a generator increases with increasing operating voltage. The startup speed is understood as the speed at which the generator begins to deliver current.

A voltage supply unit for a motor vehicle, which has an electrical system which may be supplied with electrical power by a first generator and a second auxiliary electrical system which may be supplied with electrical power by a second generator, is known from DE 100 42 524 A1. A control unit for causing power delivery is assigned to the second generator and a capacitor is connected downstream as an electrical power accumulator capable of handling high current. An electrical power delivery of the second generator may be caused via the control unit as a function of the operating state and/or the power need.

A dual-voltage supply unit for a motor vehicle is known from DE 100 42 532 A1. A generator regulator is assigned to a generator for generating electrical power. The electrical generator voltage which may be drawn from the generator may be supplied to a variable ohmic resistor via a first terminal to draw a first electrical voltage. A second terminal for drawing the vehicle electrical system voltage and the generator regulator are connected downstream from the variable ohmic resistor.

### SUMMARY OF THE INVENTION

A three-phase generator having the features specified in claim 1 has a balanced power ratio between the two voltage levels. In particular, it is distinguished by low startup speeds. The three-phase generator according to the exemplary embodiment and/or exemplary method of the present invention is also distinguished by high efficiency.

The overall system may be the electrical system of a motor vehicle, which has a first electrical system consumer group and a second electrical system consumer group in addition to the three-phase generator already cited. The first electrical system consumer group is supplied with a rated voltage, which corresponds to the first voltage value, via a unit, which may be an in-phase regulator, provided between the three-phase generator and the first electrical system consumer group. This rated voltage may be 14 V or − in the case of utility vehicles −28 V. The second electrical system consumer group is supplied with a second voltage directly from the three-phase generator, which is greater than the first rated voltage and may be 42 V or is equal to the first rated voltage.

The output voltage of the generator may be set by a control unit which also supplies control signals to the in-phase regulator. This control unit may also be integrated in the in-phase regulator.

Further advantageous features of the exemplary embodiment and/or exemplary method of the present invention result from the explanation of the exemplary embodiments as described herein.

### BRIEF DESCRIPTION OF THE DRAWINGS

FIG. 1 shows a block diagram of a vehicle electrical system according to a first embodiment of the present invention.

FIG. 2 shows a block diagram of a vehicle electrical system according to a second embodiment of the present invention.

FIG. 3 shows various types of connection of the three-phase winding of a three-phase generator.

FIG. 4 shows a partial view of the stator of a three-phase generator.

FIG. 5 shows a diagram to illustrate the curve of the generator output as a function of the number of conductors per slot.

### DETAILED DESCRIPTION

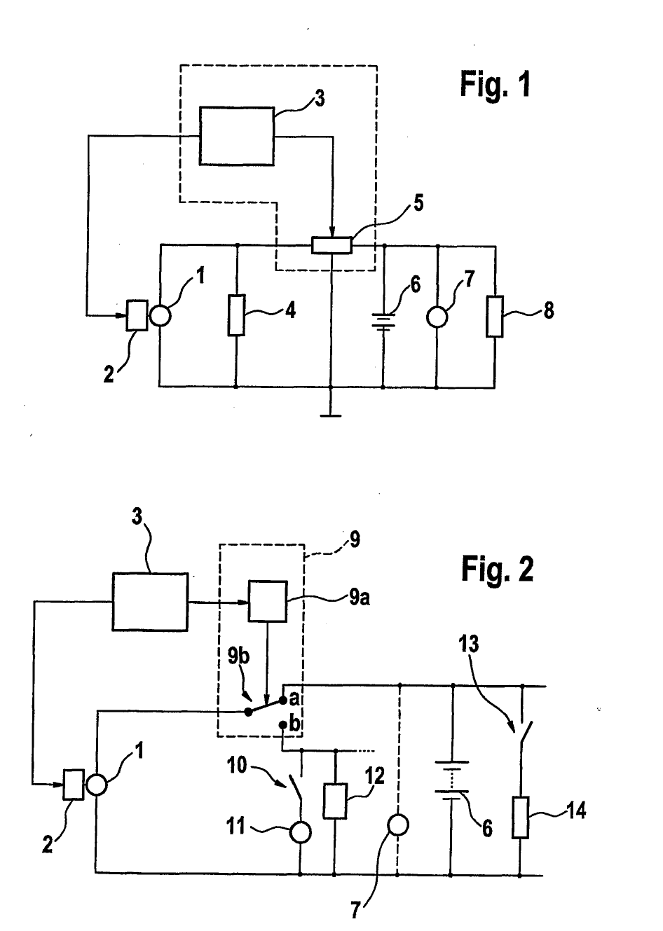

FIG. 1 shows a block diagram of a vehicle electrical system according to a first embodiment of the present invention. The vehicle electrical system shown has a generator 1, which is controlled by a regulator 2. Regulator 2 is in turn connected to a controller 3 and receives control commands for the operation of generator 1 therefrom.

The output voltage of generator 1 is settable by the control commands of controller 3 between a first voltage value and a second voltage value. The first voltage value is less than 14 V. The second voltage value may be greater than 36 V.

The output of generator 1 is connected to an electrical system consumer 4, which is a 42-V consumer. Furthermore, generator 1 is connected to an in-phase regulator 5, which is also impinged with control signals by controller 3. Controller 3 and in-phase regulator 5 may be implemented as a modular unit—as indicated in FIG. 1 by the dashed lines. The typical electrical system of the motor vehicle, which includes a battery 6 and an electrical system consumer 8, is provided at the output of in-phase regulator 5. The electrical system consumer is a 12-V consumer. Optionally, a further generator 7 is provided. Battery 6 may be a 12-V lead storage battery. In-phase regulator 5 provides a constant voltage of approximately 14 V at its output, which is used to charge lead storage battery 6 and to supply 12-V consumer 8.

The device illustrated in FIG. 1 is actually used for the purpose of operating specific consumers, such as an electrical heater and the engine cooling fan, at a higher or variable voltage, which is freely selectable in the range between 14 V and 42 V, and for simultaneously supplying the remaining electrical system with 14 V via in-phase regulator 5.

An alternative possible use of the device according to FIG. 1 exists in utility vehicles. In these utility vehicles, the first voltage value, at which the remaining electrical system is supplied, is 28 V. As a result, a supply DC voltage of 28 V is provided at the output of in-phase regulator 5 in this alternative use. Generator 1 operates in a voltage range between 28 V and 42 V in this alternative possible use.

To be able to operate optimally in the cited voltage ranges, generator 1 is designed characteristically according to the exemplary embodiment and/or exemplary method of the present invention. This design of the generator is explained in greater detail below in connection with FIGS. 3 through 5.

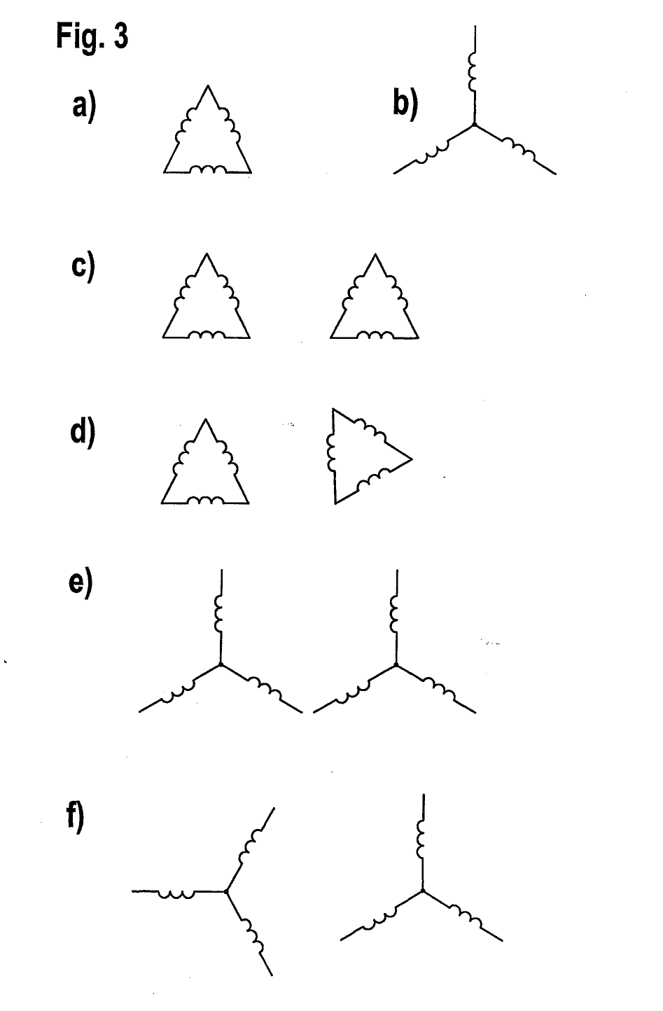

FIG. 2 shows a block diagram of a vehicle electrical system according to a second embodiment of the present invention. The vehicle electrical system illustrated in FIG. 2 has a generator 1, which is controlled by a regulator 2. Regulator 2 is in turn connected to a controller 3 and receives control commands for the operation of generator 1 therefrom.

The output voltage of generator 1 is settable between a first voltage value and a second voltage value by the control commands of controller 3. The first voltage value is less than 14V. The second voltage value may be greater than 36 V.

The output of generator 1 is connected to a switching device 9. This switching device, to which control commands are supplied from controller 3, has a switching unit 9a and a switch 9b. The two-way contact of switch 9b is connected to generator 1. A typical partial vehicle electrical system, of which a battery 6 and a 12-V consumer 14, connected to a switch 13, are illustrated in FIG. 2, is connected to terminal a of switch 9b. Terminal b of switch 9b is connected to a switch 10, connected in series with a fan motor 11. Fan motor 11 is supplied with a DC voltage, which may be between 14 V and 42 V, from generator 1 when switch 10 is closed. A further consumer, which may also be supplied with the variable voltage, is situated in parallel to the series circuit made of switch 10 and fan motor 11. Controller 3 controls the changeover of switch 9b during driving operation in such a way that those components which require power are connected to generator 1. If switch 9b is in its switch position a, the conventional 14-V vehicle electrical system is supplied by generator 1 and possibly by optional generator 7 with a supply DC voltage of 14 V. In contrast, if switch 9b is in its switch position b, 42-V consumers 11 and/or 12 are supplied by generator 1 with a supply DC voltage of up to 42 V, while the 14-V vehicle electrical system may be supplied by optional generator 7 if necessary.

In order to be able to operate optimally in both above-mentioned voltage ranges, generator 1 is designed in a characteristic way according to the exemplary embodiment and/or exemplary method of the present invention. The design of the generator is explained in greater detail in the following in connection with FIGS. 3 through 5.

The generator according to the exemplary embodiment and/or exemplary method of the present invention is a three-phase generator. It has a stator around whose teeth a three-phase winding is wound, whose winding phases are positioned in slots located between the teeth. The three-phase winding may have various types of interconnection. These are explained in the following on the basis of FIG. 3.

FIG. 3a shows a delta connection: of the three-phase winding. The winding phases are interconnected with one another triangularly therein, the electrical angle between neighboring winding phases being approximately 120° in each case.

FIG. 3b shows a star connection: of the three-phase winding. The winding phases are interconnected with one another in a star shape therein, the electrical angle between neighboring winding phases being approximately 120° in each case.

FIG. 3c shows a double delta connection: of the three-phase winding. This includes two partial windings which are wound identically in the stator but are electrically isolated from one another in the stator, whose winding phases are each interconnected triangularly and which are situated in-phase to one another in the stator. This is implemented in that the stator and/or the stator assembly has a slot count which is precisely as high as in the case where the single delta connection shown in FIG. 3a is provided. Two parallel identical windings are laid in the same slots of the stator, but are each connected separately to form a delta system. A symmetrical use of the rectifier diodes of both systems is thus obtained.

FIG. 3d shows a further double delta connection: of the three-phase winding. This includes two partial windings, which are wound in the stator but are electrically isolated from one another in the stator, whose winding phases are each connected triangularly and are situated electrically offset by approximately 30° to one another in the stator. This is implemented in that the stator and/or the stator assembly has a slot count which is twice as high as in the case of the single delta connection: shown in FIG. 3a. One slot which is occupied by a winding phase of the second delta connection lies between each two slots which are occupied by winding phases of the first delta connection.

FIG. 3e shows a double star connection: of the three-phase winding. This includes two partial windings, which are wound identically in the stator but are electrically isolated from one another in the stator, whose winding phases are each interconnected in a star shape and are situated in-phase to one another in the stator. This is implemented in that the stator and/or the stator assembly has a slot count which is precisely as high as in the case where the single star connection shown in FIG. 3b is provided. Two parallel identical windings are laid in the same slots of the stator, but are each interconnected separately to form a star system. A symmetrical use of the rectifier diodes of both systems is thus obtained.

FIG. 3f shows a double star connection: of the three-phase winding. This includes two partial windings, which are wound identically in the stator but are electrically isolated from one another in the stator, whose winding phases are each interconnected in a star shape and are situated offset electrically to one another by approximately 30° in the stator. This is implemented in that the stator and/or the stator assembly has a slot count which is twice as high as in the case where the single star connection: shown in FIG. 3b is provided. One slot which is occupied by a winding phase of the second star connection: lies between each two slots which are occupied by winding phases of the first star connection.

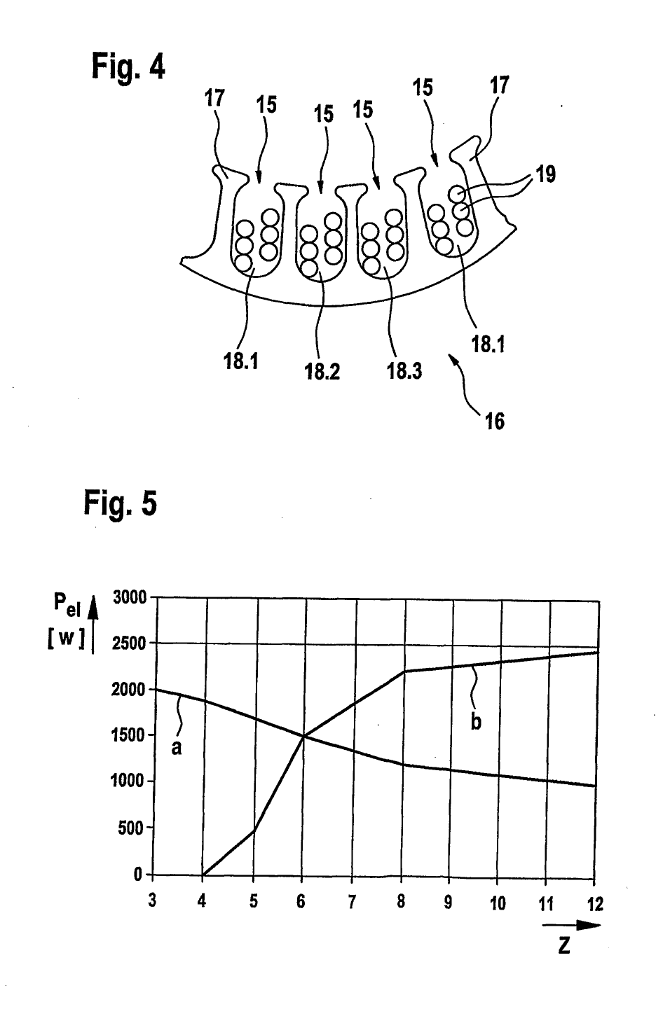

FIG. 4 shows a partial view of the stator of a three-phase generator according to the exemplary embodiment and/or exemplary method of the present invention. It may be seen from this illustration that stator 16 has multiple teeth 17. If a 12-pole three-phase generator is provided, then in case of an implementation according to FIG. 3a, 3b, 3c, or 3e, the total number of teeth is 36. In case of an implementation according to FIG. 3d or 3f, the total number of teeth is 72. If an 8-pole three-phase generator is provided, in the case of an implementation according to FIG. 3a, 3b, 3c, or 3e, the total number of teeth is 48. In case of an implementation according to FIG. 3d or 3f, the total number of teeth is 96. A three-phase winding is wound around teeth 17 of stator 16, whose winding phases 18.1, 18.2, and 18.3 are positioned in slots 15 of the stator located between teeth 17. Each of these winding phases 18.1, 18.2, and 18.3 has a predefined number of wires 19.

A conductor is defined in the following as:
a conductor is a component provided for conducting electrical current;
a conductor is the part of a winding which lies in the slot;
the cross-section of a conductor may be distributed to one or more wires (parallel wire count a);
two conductors connected to one another, which are separated from one another at the distance of a pole pitch, form a turn;
the totality of all locally concentrated turns of a winding connected in series, having simultaneous electrical effect in regard to the basic electrical processes, is referred to as a coil;
in single-layer lap windings, every winding phase of each pole pair p has a coil.

Number z of conductors per slot corresponds to the coil turn count. The number of wires 19 in a slot accordingly results from number z of the conductors per slot multiplied by number a of parallel wires per conductor. Number z of conductors per slot is selected in such a way that the three-phase generator has a balanced output ratio between the voltage levels 14 V and 42 V and/or, in utility vehicles, between 28 V and 42 V. Furthermore, cited predefined number z of the conductors per slot is also selected in such a way that the startup speed of the generator is as low as possible in 42-V operation. Furthermore, the predefined number of conductors per slot is a function of the type of connection of the three-phase winding.

According to the exemplary embodiment and/or exemplary method of the present invention, if single-slot-per-phase windings are provided, number z of conductors per slot is selected as a function of the type of connection of the three-phase winding as follows:
if the first voltage value is 14 V:
delta connection: 5≦z≦10
double delta connection: 5≦z≦10
star connection: 2≦z≦8
double star connection: 2≦z≦8
if the first voltage value is 28 V:
delta connection: 7≦z≦17
double delta connection: 7≦z≦17
star connection: 4≦z≦10
double star connection: 4≦z≦10.

Furthermore, according to the exemplary embodiment and/or exemplary method of the present invention, if two-slot-per-phase windings are provided, number z of conductors per slot is selected as a function of the type of connection of the three-phase winding as follows:
if the first voltage value is 14 V:
delta connection: 3≦z≦6
double delta connection: 3≦z≦6
star connection: 1≦z≦5
double star connection: 1≦z≦5
if the first voltage value is 28 V:
delta connection: 4≦z≦9
double delta connection: 4≦z≦9
star connection: 2≦z≦6
double star connection: 2≦z≦6.

Especially good results are achieved if, when single-slot-per-phase windings are provided, number z of conductors per slot is selected as a function of the type of connection of the three-phase winding as follows:
if the first voltage value is 14 V:
delta connection: 5≦z≦7
double delta connection: 5≦z≦7
star connection: 2≦z≦5
double star connection: 2≦z≦5
if the first voltage value is 28 V:
delta connection: 7≦z≦13
double delta connection: 7≦z≦13
star connection: 4≦z≦7
double star connection: 4≦z≦7.

Especially good results are achieved if, when two-slot-per-phase windings are provided, number z of conductors per slot is selected as a function of the type of connection of the three-phase winding as follows:
if the first voltage value is 14 V:
delta connection: 3≦z≦4
double delta connection: 3≦z≦4
star connection: 1≦z≦4
double star connection: 1≦z≦4
if the first voltage value is 28 V:
delta connection: 4≦z≦7
double delta connection: 4≦z≦7
star connection: 2≦z≦4
double star connection: 2≦z≦4.

It may especially be the case, when single-slot-per-phase windings are provided, number z of conductors per slot is selected as a function of the type of connection of the three-phase winding as follows:
if the first voltage value is 14 V:
delta connection: 5≦z≦6
double delta connection: 5≦z≦6
star connection: 3≦z≦4
double star connection: 3≦z≦4
if the first voltage value is 28 V:
delta connection: 7≦z≦10
double delta connection: 7≦z≦10
star connection: 5≦z≦7
double star connection: 5≦z≦7.

It may especially be the case, when two-slot-per-phase windings are provided, number z of conductors per slot is selected as a function of the type of connection of the three-phase winding as follows:
if the first voltage value is 14 V:
delta connection: 3≦z≦4
double delta connection: 3≦z≦4
star connection: 2≦z≦3
double star connection: 2≦z≦3
if the first voltage value is 28 V:
delta connection: 5≦z≦6
double delta connection: 5≦z≦6
star connection: 3≦z≦4
double star connection: 3≦z≦4.

Single-slot-per-phase windings are provided if the following relationship applies:

N=2*p*m,

N being the slot count of the stator, p being the pole pair count, and m being the number of winding phases of the stator winding.

Two-slot-per-phase windings are provided if the following relationship applies:

N=4*p*m,

N being the slot count of the stator, p being the pole pair count, and m being the winding phase count of the stator, and if conductors of the same winding phase lie in at least two neighboring slots.

FIG. 5 shows a diagram to illustrate the curve of generator output Pₑₗ as a function of number z of conductors per slot. Curve a describes the curve of generator output Pₑₗ when the generator operates in a first voltage range, which is at 13.5 V, and curve b describes the curve of generator output Pₑₗ when the generator operates in a second voltage range, which is at 40.5 V.

Curves a and b were measured on a generator whose stator internal diameter is 112 mm, whose three-phase winding is wound as defined by a delta connection: shown in FIG. 3a, whose speed is 3000 rpm, and whose copper fill factor is approximately 60%. The quotient of the total copper cross-sectional area of all wires in a slot and the cross-sectional area of the slot is understood as the copper fill factor.

It may be seen from curve a that the generator output in the first voltage range of 13.5 V is approximately 2.0 kW if three conductors per slot are used, it is approximately 1.0 kW if twelve conductors per slot are used, and it has an essentially linearly decreasing curve for conductor counts lying in between. Curve b shows that the generator output in the second voltage range of 40.5 V is still zero if three or four conductors per slot are used, increases strongly for conductor counts per slot of four to eight, and only increases slightly further for conductor counts per slot which are greater than eight.

In the conductor counts per slot specified in the patent claims, it is taken into consideration that the generator operates during most of the operating time at the first voltage level, i.e., at approximately 14 V in typical passenger vehicles and at approximately 28 V if utility vehicles are provided, and the higher voltage of 42 V is required for only a small part of the operating time. The latter is true in particular if the engine is still cold and must be heated. For this reason, the conductor count per slot is selected in such a way that the current characteristic lines and the efficiency of the generator are optimized predominantly at the first voltage level, but a sufficient output capability is still provided up to the second voltage level.

The list of reference numerals is as follows:
1 generator,
2 regulator,
3 controller,
4 second electrical system consumer group,
5 in-phase regulator—voltage adaptation component,
6 battery,
7 generator,
8 first electrical system consumer group,
9 switching device,
9a switching unit,
9b switch,
10 switch,
11 fan motor,
12 14-V-42-V consumer,
13 switch,
14 14 V consumer,
15 slots,
16 stator,
17 teeth,
18.1, 18.2, 18.3 wires of one winding phase each,
19 wires.

1-22. (canceled)

23. A three-phase generator having an output voltage settable between a first voltage value and a second voltage value, the first voltage value being provided for supplying electrical system consumers of a motor vehicle and the second voltage value being greater than the first voltage value, comprising:
a stator around whose teeth a three-phase winding is wound, whose winding phases are positioned in slots located between the teeth, each winding phase having a number of conductors per slot,
wherein:
if single-slot-per-phase windings are provided, the number of conductors per slot being selected as a function of the type of connection of the three-phase winding as follows:
if the first voltage value is 14 V:
delta connection: 5≦z≦10
double delta connection: 5≦z≦10
star connection: 2≦z≦8
double star connection: 2≦z≦8, and
if the first voltage value is 28 V:
delta connection: 7≦z≦17
double delta connection: 7≦z≦17
star connection: 4≦z≦10
double star connection: 4≦z≦10, and
wherein:
if two-slot-per-phase windings are provided, the number of conductors per slot being selected as a function of the type of connection of the three-phase winding as follows:
if the first voltage value is 14 V:
delta connection: 3≦z≦6
double delta connection: 3≦z≦6.
star connection: 1≦z≦5
double star connection: 1≦z≦5, and
if the first voltage value is 28 V:
delta connection: 4≦z≦9
double delta connection: 4≦z≦9
star connection: 2≦z≦6.
double star connection: 2≦z≦6.

24. The three-phase generator of claim 23, wherein:
when single-slot-per-phase windings are provided, the number of the conductors per slot is selected as a function of the type of connection of the three-phase winding as follows:
if the first voltage value is 14 V:
delta connection: 5≦z≦7
double delta connection: 5≦z≦7
star connection: 2≦z≦5
double star connection: 2≦z≦5, and
if the first voltage value is 28 V:
delta connection: 7≦z≦13
double delta connection: 7≦z≦13
star connection: 4≦z≦7
double star connection: 4≦z≦7, and
when two-slot-per-phase windings are provided, the number of conductors per slot being selected as a function of the type of connection of the three-phase winding as follows:
if the first voltage value is 14 V:
delta connection: 3≦z≦4
double delta connection: 3≦z≦4
star connection: 1≦z≦4
double star connection: 1≦z≦4, and
if the first voltage value is 28 V:
delta connection: 4≦z≦7
double delta connection: 4≦z≦7
star connection: 2≦z≦4
double star connection: 2≦z≦4.

25. The three-phase generator of claim 24, wherein:
when single-slot-per-phase windings are provided, the number of conductors per slot is selected as a function of the type of connection of the three-phase winding as follows:
if the first voltage value is 14 V:
delta connection: 5≦z≦6
double delta connection: 5≦z≦6
star connection: 3≦z≦4
double star connection: 3≦z≦4, and
if the first voltage value is 28 V:
delta connection: 7≦z≦10
double delta connection: 7≦z≦10
star connection: 5≦z≦7
double star connection: 5≦z≦7; and
when two-slot-per-phase windings are provided, the number of conductors per slot being selected as a function of the type of connection of the three-phase winding as follows:
if the first voltage value is 14 V:
delta connection: 3≦z≦4
double delta connection: 3≦z≦4
star connection: 2≦z≦3
double star connection: 2≦z and
if the first voltage value is 28 V:
delta connection: 5≦z≦6
double delta connection: 5≦z≦6
star connection: 3≦z≦4
double star connection: 3≦z≦4.

26. The three-phase generator of claim 23, wherein the slot fill factor is between 45% and 70%.

27. The three-phase generator of claim 26, wherein the slot fill factor is between 50% and 70%.

28. The three-phase generator of claim 27, wherein the slot fill factor is between 55% and 70%.

29. The three-phase generator of claim 28, wherein the slot fill factor is between 60% and 70%.

30. The three-phase generator of claim 23, wherein the second voltage value is 42 V.

31. The three-phase generator of claim 23, wherein the following relationship applies for the number of its poles: 10≦n≦18

32. The three-phase generator of claim 23, wherein its output voltage is settable using a regulator.

33. The three-phase generator of claim 32, wherein the regulator is mounted on the generator.

34. The three-phase generator of claim 23, wherein Zener diodes are used for limiting the output voltage above the second voltage level.

35. The three-phase generator of claim 23, wherein the greatest predefinable voltage value is at least 8 V greater than the smallest predefinable voltage value.

36. An electrical system of a motor vehicle, comprising:
a three-phase generator having an output voltage settable between a first voltage value and a second voltage value, the first voltage value being provided for supplying electrical system consumers of a motor vehicle and the second voltage value being greater than the first voltage value, including:
a stator around whose teeth a three-phase winding is wound, whose winding phases are positioned in slots located between the teeth, each winding phase having a number of conductors per slot,
wherein:
if single-slot-per-phase windings are provided, the number of conductors per slot being selected as a function of the type of connection of the three-phase winding as follows:
if the first voltage value is 14 V:
delta connection: 5≦z≦10
double delta connection: 5≦z≦10
star connection: 2≦z≦8
double star connection: 2≦z≦8, and
if the first voltage value is 28 V:
delta connection: 7≦z≦17
double delta connection: 7≦z≦17
star connection: 4≦z≦10
double star connection: 4≦z≦10, and
wherein:
if two-slot-per-phase windings are provided, the number of conductors per slot being selected as a function of the type of connection of the three-phase winding as follows:
if the first voltage value is 14 V:
delta connection: 3≦z≦6
double delta connection: 3≦z≦6
star connection: 1≦z≦5
double star connection: 1≦z≦5, and
if the first voltage value is 28 V:
delta connection: 4≦z≦9
double delta connection: 4≦z≦9
star connection: 2≦z≦6
double star connection: 2≦z≦6;
a first electrical system consumer, which is supplied with a rated voltage, which corresponds to the first voltage value, via a unit provided between the three-phase generator and the first electrical system consumer; and
a second electrical system consumer, which is supplied with a second rated voltage, which is greater than the first rated voltage, directly from the three-phase generator.

37. The vehicle electrical system of claim 36, wherein the unit provided between the three-phase generator and the first electrical system consumer is an in-phase regulator.

38. The vehicle electrical system of claim 36, wherein the unit provided between the three-phase generator and the first vehicle system consumer is a switching device.

39. The vehicle electrical system of claim 36, wherein a further, additional generator is provided to supply the first electrical system consumer.

40. The vehicle electrical system of claim 36, wherein it has a control unit, which supplies control signals to the regulator of the generator to set the output voltage of the generator.

41. The vehicle electrical system of claim 37, wherein the control unit supplies control signals to the in-phase regulator.

42. The vehicle electrical system of claim 37, wherein the control unit and the in-phase regulator form a structural unit.

43. The vehicle electrical system of claim 38, wherein the control unit supplies switchover signals to the switching device.

44. The vehicle electrical system of claim 36, wherein the second voltage value is greater by at least 8 V than the first voltage value.
